(19) United States
(12) Patent Application Publication
(10) Pub. No.: US 2019/0202369 A1
(43) Pub. Date: Jul. 4, 2019

(54) COMPUTER TABLET CASE WITH REAR MOUNTING

(71) Applicant: Jordan Nemitz, Ankeny, IA (US)

(72) Inventor: Jordan Nemitz, Ankeny, IA (US)

(21) Appl. No.: 15/858,952

(22) Filed: Dec. 29, 2017

(51) Int. Cl. B60R 11/02

(52) U.S. Cl. CPC B60R 11/0252; B60R 2011/007; B60R 2011/0276

(57) ABSTRACT

A carrier for personal digital device includes a frame with a pocket therein for holding the device. The frame has a front wall with an open window to allow use in viewing of the device. A slot is formed in one of the perimeter edges of the frame to which the device passes into and out of the pocket. The back of the carrier includes mounts for securing the carrier to a substantially vertical support. Such as an automotive headrest or a flat panel or wall.

### FIELD OF THE INVENTION

The present invention is directed towards a carrier for electronical or digital devices, such as a tablet or laptop.

### BACKGROUND OF THE INVENTION

Computer laptop and tablets are commonly used in many environments and settings, typically are rested on a horizontal support surface or the user's lap. It is common to protect the device with some type of cover, which normally folds open to allow the device to be used. Sometimes a table or desk or other horizontal surfaces is not available, but it is desired to keep the user's lap free of obstructions, though neither the device nor it's carrier can be mounted on a vertical surface, which will be useful.

Therefore, a primary objective of the present invention is a provision of a carrier for an electronic or digital device, such as a tablet or laptop, which can be mounted to a vertical or substantially vertical support surface.

Another objective of the present invention is a provision of a tablet carrier which protects the tablet without covering the face of the tablet.

Yet another objective of the present invention is a provision of a carrier for tablets and laptops which can be mounted to an automotive headrest for use by the person sitting in a seat behind the headrest.

Still another objective of the present invention is a provision of a carrier for tablets and laptops which can be magnetically mounted to a surface in a vertical orientation.

Another objective of the present invention is a provision of a tablet carrier having a slot for slideably receiving the tablet within the frame of the carrier.

A further objective of the present invention is a provision of a tablet carrier which is economically manufactured, and durable and safe in use.

These and other objectives have become apparent from the following description of the invention.

### SUMMARY OF THE INVENTION

A carrier is provided for electronic or digital tablet or laptop. The carrier comprises a rigid housing having a front with an opening for viewing and touching the tablet, a back, and four sides. A slot is formed in one of the sides for inserting the tablet or laptop into the housing. A mounting system is provided on the back of the housing to mount the housing to a substantially vertical support surface. In one embodiment, the mounting system includes a pair of blocks with vertical holes for receiving the legs of an automotive head rest, such that the carrier and tablet are supported by the head rest for viewing by a person sitting in the seat immediately behind the headrest. The blocks are hinged to the carrier frame and are spring biased. In another embodiment, the mounting system comprises a plurality of magnets to magnetically couple the carrier to a magnetically receptive support service. The tablet in the second embodiment carrier can be positioned in both a landscape and portrait orientation on the support surface.

### BRIEF DESCRIPTION OF THE DRAWINGS

FIG. 1 is a front view of a digital or electronic device carrier according to the present invention, without the device mounted therein.

FIG. 2 is a front perspective view showing a device positioned within the carrier.

FIG. 3 is a front perspective view showing a tablet partially inserted through the side slot in the carrier.

FIG. 4 is another perspective view showing tablet partially inserted through the slot in the side of the carrier.

FIG. 5 is a rear perspective view of the carrier, with a first embodiment of the mounting system of the carrier.

FIG. 6 is another rear perspective view showing the first mounting system embodiment.

FIG. 7 is a close-up view showing the hinge and springs of the first embodiment mounting system.

FIG. 8 is an end view of the carrier with a second embodiment of the mounting system.

FIG. 9 is a rear view of the carrier showing the second embodiment of the mounting system.

FIG. 10 is a view of the carrier mounted on an automotive headrest.

### DETAILED DESCRIPTION OF THE PREFERRED EMBODIMENTS

The tablet or laptop carrier of the present invention is generally designated in the drawings by the reference numeral 10, and provides a protective housing for the tablet or laptop 12. The carrier 10 has a front 14 in the form of a frame with an opened window to the tablet 12. The carrier 10 also has an enclosed back wall 16, with a perimeter edge 18 defining four sides of the housing. A slot 20 is provided in one of the edges of sides 18 through which the laptop or tablet 12 can be inserted into the pocket formed between the front 14 and the back 16. A closure device may be provided to retain the tablet 12 within the carrier 10, and avoid accidental sliding of the tablet out of the slot 20. For example, the closure device may be an insert or plug 21, as shown in FIG. 2. The plug 21 may be secured by a friction fit in the slot 20, or by magnets 23 in the plug and magnets 25 in the frame 10, or by any other convenient means. The plug 21 may have a built-in charger connection for the tablet 12. As an alternative to the plug insert 21, the closure device may be a Velcro strap, a strap with a snap or clip, a magnetic closure, a sliding closure, or a closure flap. The frame 10 may have battery compartment for powering the tablet 12 when the tablet in inserted into the frame.

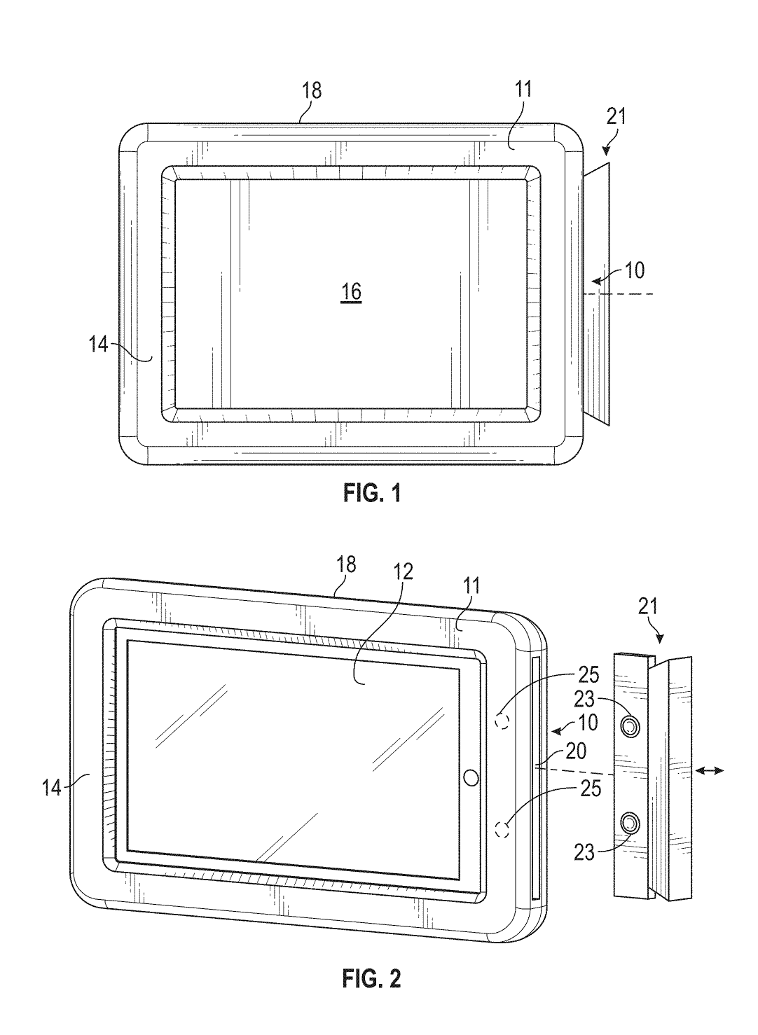

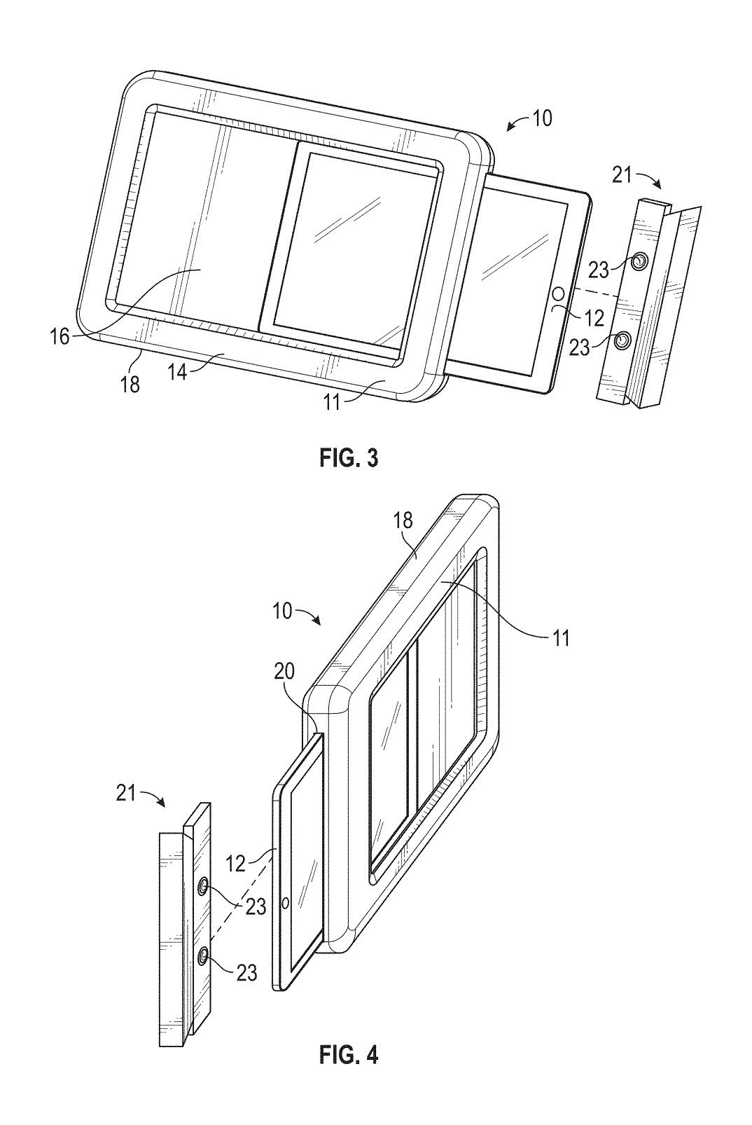

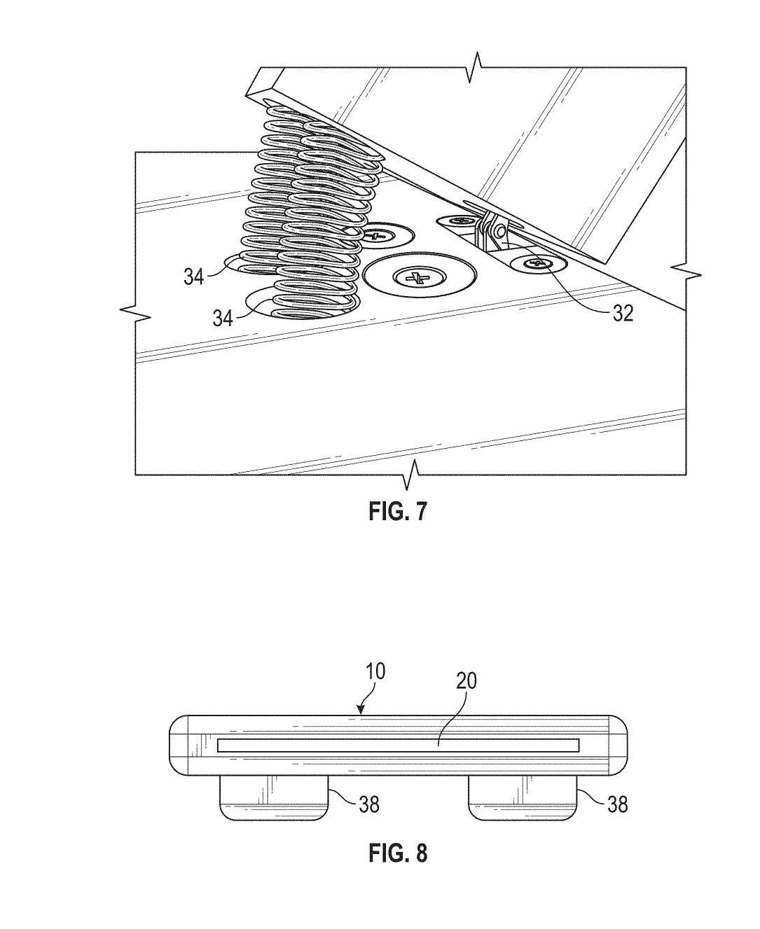

The carrier 10 is adapted to be mounted so as to support the tablet 12 in a substantially vertical or upright orientation from viewing and use. In a first embodiment shown in FIGS. 1-7, the carrier 10 includes a pair of blocks 24 attached to the back wall 16. The blocks 24 each have a hole therein, and are spaced so as to receive the posts 28 of an automotive headrest 30, as shown in FIG. 10. The blocks 24 may be fixed to the back wall 16, or more preferably, maybe mounted via a hinge 32 such that the tablet 12 can be pivoted about the hinge axis when the carrier 10 is mounted on the headrest 30. One or more springs 34 maybe provided between the blocks 24 and the back wall 16, so as to urge or bias carrier frame to the upright orientation. Hinge 32 and the spring 34 provide a safety feature for the carrier 10, in the event that a child or person pulls or accidentally grabs the frame while entering or exiting the vehicle. Removable shims may be provided for insertion adjacent the hinges to modify the viewing angle.

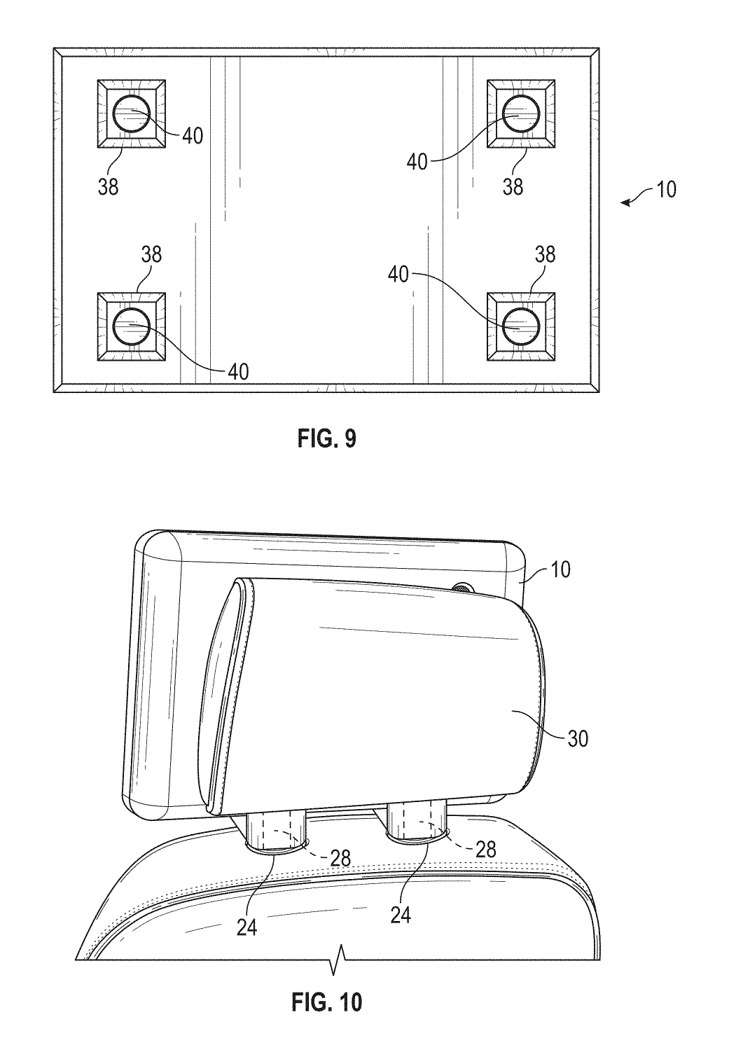

In a second embodiment, shown in FIGS. 8 and 9, the mounting mechanism of the carrier 10 comprises one or more magnetics or magnetically mounting the carrier to a surface. For example, as seen in FIG. 8, legs 38 extend from the back wall 16 of the carrier 10, with a magnetic 40 secured on each of the leg. The magnetics can be used to attach the carrier 10, with tablet 12 wherein, to a magnetic surface, such as a refrigerator, the exterior body of the vehicle, or to a wall having magnetics or a steel plate embedded therein. The magnetics 40 permit the carrier to be oriented in a portrait or landscape position, as desired by the user.

The carrier 10 allows the tablet or laptop 12 to be used, without sitting on the user's lap, and in the absence of horizontal support surface, such as a table or desk. The mounting blocks 24 and mounting magnetics 40 allow the carrier 10 to be safely retained in a desired mounted position, even when the user gets up, moves, or is absent from their seat or chair.

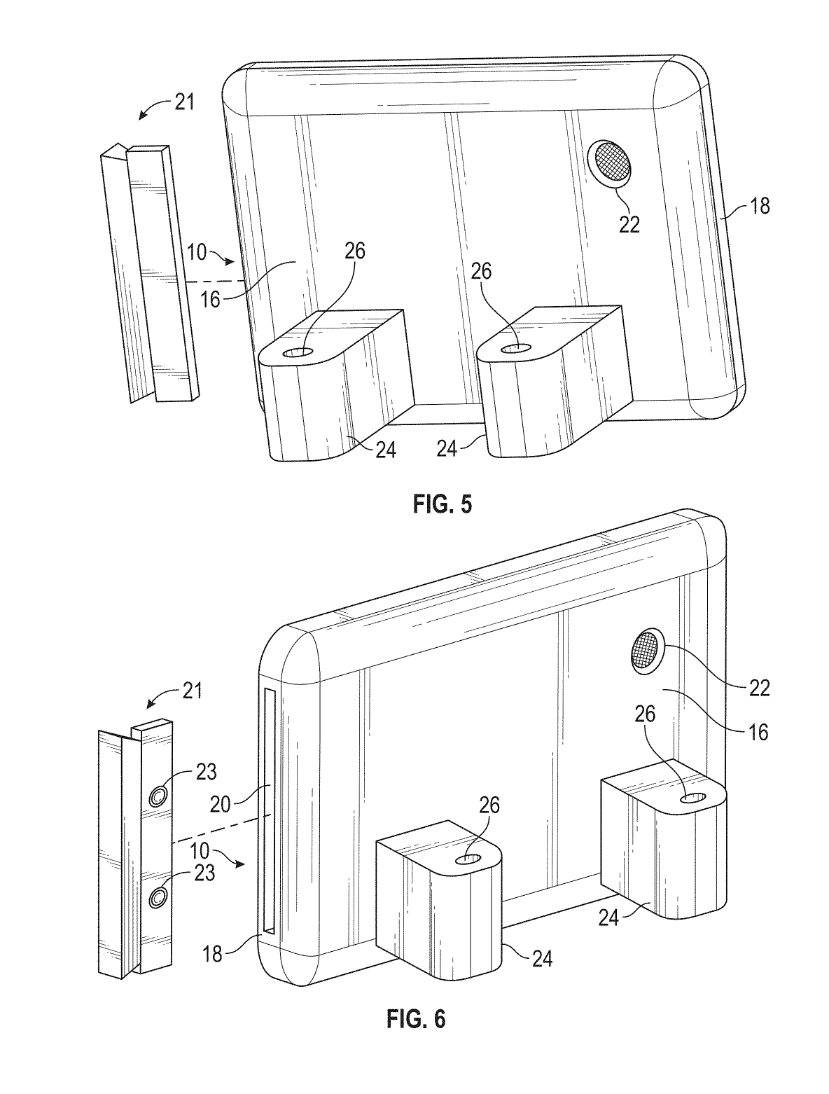

While the drawings show the slot 20 in a lateral side edge of the carrier, it is understood that the slot could also be formed in the top edge of a carrier. Also, the magnetics 40 can be attached directly to the back wall 16, without the legs 38, if desired. As seen in FIG. 5, the back wall 16 of the carrier 10 has a hole 22 to accommodate the standard camera on the back of the tablet or laptop 12. It is understood that the location of the hole 22 would be specific to the particular brand of tablet or carrier to be housed in the carrier 10. The hole 22 allows the laptop or tablet camera to be used without the removing the laptop or tablet 12 from the carrier 10.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. An electronic tablet carrier, comprising:
a rigid housing having a front with an opening for viewing and torching the tablet, a back, and four sides; and
one of the sides having a slot for inserting the tablet into the housing.

2. The electronic tablet carrier of claim 1 further comprising a mounting system on the back of the housing for mounting the housing to a support.

3. The electronic tablet carrier of claim 2 wherein the mounting system is at least one magnet to magnetically couple the carrier to the support.

4. The electronic tablet carrier of claim 2 wherein the mounting system includes a plurality of legs with a magnet on the end of each leg.

5. The electronic tablet carrier of claim 2 wherein the mounting system is a pair of blocks with vertically disposed holes for receiving legs of an automotive head rest.

6. The electronic tablet carrier of claim 3 wherein the blocks are spring biased.

7. The electronic tablet carrier of claim 3 further comprising a spring between each block and the back of the housing.

8. The electronic tablet carrier of claim 3 further comprising a hinge to connect each block to the back of the housing.

9. The electronic tablet carrier of claim 6 wherein each hinge is spring biased.

10. The electronic tablet carrier of claim 1 wherein the one side with the slot is on a top edge of the housing.

11. A carrier for a personal digital device, comprising:
a frame having a pocket for holding the personal digital device;
the frame having an upper edge, a bottom edge, and opposite side edges;
a slot in one of the upper and side edges through which the personal digital device passes into and out of the pocket;
a window on a front of the frame for operating the personal digital device; and
a mount mechanism on a back of the frame to mount the frame on a substantially vertical support.

12. The carrier of claim 11 wherein the mount mechanism includes a plurality of magnets.

13. The carrier of claim 12 further comprising a plurality of spaces on the back of the frame, and the magnets being on outer ends of the spacers.

14. The carrier of claim 11 wherein the mount mechanism includes at least one block wherein a substantially vertical hole adapted to receive a post on a headrest in an automobile.

15. The carrier of claim 11 wherein the block is hinged to the back of the frame.

16. The carrier of claim 15 further comprising a spring extending between the block of the frame.

17. The carrier of claim 16 wherein the spring biased the frame towards the block.

18. The carrier of claim 11 wherein the window is open to allow touching of the personal digital device.

19. The carrier of claim 11 wherein the frame is rigid.

20. The carrier of claim 11 wherein the frame has a front and a back which are fixed together without movement therebetween.
